(19) United States
(12) Patent Application Publication
(10) Pub. No.: US 2026/0281153 A1
(43) Pub. Date: Sep. 17, 2026

(54) Multi-Level Approach For Attack Prevention

(71) Applicant: Musarubra US LLC, Plano, TX (US)

(72) Inventors: Gururajan Padmanaban, Tamil Nadu (IN); Praveen Soraganvi, Prosper, TX (US)

(21) Appl. No.: 19/080,650

(22) Filed: Mar. 14, 2025

(51) Int. Cl. H04L 9/40; G06F 40/226

(52) U.S. Cl. CPC H04L 63/1466; G06F 40/226

(57) ABSTRACT

A computerized method is disclosed that includes operations of preventing an attack from harming a large language model (LLM). The method includes an evaluator and an analyzer. The evaluator is configured to evaluate a communication from a user using N first classifiers to provide N first classifications. The communication interacts with the LLM. The analyzer is configured to analyze the N first classifications to generate an assessment having a first value. The assessment characterizes an attack level in the communication. The analyzer obtains a response to the communication from the LLM based on the first value and reviews the response using M second classifiers to generating a decision on the response. N is a positive integer and M is a positive integer equal to or different from N.

### FIELD

Embodiments of the disclosure generally relate to the field of security in artificial intelligence (AI) systems. In particular, embodiments of the disclosure relate to techniques in attack prevention for large language models (LLMs).

### GENERAL BACKGROUND

Large Language Models (LLMs) have become increasingly popular in systems using artificial intelligence (AI). LLMs are designed to understand human language, interpret texts, and generate textual responses. Due to their ability to be trained on a variety of subjects and their access to very large amounts of information, LLMs have many applications including content creation, inquiry-response system, chatbots, summarization, market research, and education.

LLMs have been known to be vulnerable to intrusion or attack because they are trained on large amounts of data which may contain sensitive information, biases, and confidential data. Attacks may take on several forms including prompt injection, jailbreaking, data poisoning attacks, and privacy breaches. Existing techniques in attack detection and prevention have a number of drawbacks including narrow scope of detection, lack of flexibility, and inability to handle context-dependent threats.

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1A is a block diagram illustrating an attack prevention system (APS) configured to perform on premises in accordance with some embodiments;

FIG. 1B is a block diagram illustrating an APS configured to perform in a cloud-based network environment in accordance with some embodiments;

FIG. 1C is a block diagram illustrating an APS configured to perform in a hybrid mode including on-premise and cloud-based network environment in accordance with some embodiments;

FIG. 2 is a block diagram illustrating the functional structure of the APS shown in FIG. 1 in accordance with some embodiments;

FIG. 3 is a block diagram illustrating the evaluator as shown in FIG. 2 in accordance with some embodiments;

FIG. 4 is a block diagram illustrating the analyzer and administrator (AAA) as shown in FIG. 2 in accordance with some embodiments;

FIG. 5 is a block diagram illustrating the validator as shown in FIG. 4 in accordance with some embodiments;

FIG. 6 is a flowchart illustrating a process of attack prevention in accordance with some embodiments;

FIG. 7 is a flowchart illustrating a process of evaluating a communication in accordance with some embodiments;

FIG. 8 is a flowchart illustrating a process of analyzing the N first classifications in accordance with some embodiments;

FIG. 9 is a flowchart illustrating a process of obtaining a response in accordance with some embodiments;

FIG. 10 is a flowchart illustrating a process of reviewing the response in accordance with some embodiments;

FIG. 11 is a block diagram illustrating examples of classifications in accordance with some embodiments; and

FIG. 12 is a block diagram illustrating a computing system that implements the intrusion prevention in accordance with some embodiments.

### DETAILED DESCRIPTION

To overcome the disadvantages of existing techniques in dealing with malicious attacks on AI-based systems, the systems and methods in this disclosure provide flexible and efficient solutions for generating decisions regarding the assessment of potential threats in a communication from a user. The architecture of the solution provides a modular approach to incorporate various classifiers and a systematic technique to fuse or integrate the outputs of these classifiers to generate reliable decisions or outcomes in characterizing the communication including a determination of whether the communication is an attack or a benign communication. In one embodiment, the architecture includes an evaluator and an analyzer. The evaluator is configured to evaluate a communication from a user using N first classifiers to provide N first classifications. The communication interacts with the LLM. The analyzer is configured to analyze the N first classifications to generate an assessment having a first value. The assessment characterizes an attack level in the communication. The analyzer obtains a response to the communication from the LLM based on the first value and reviews the response using M second classifiers to generating a decision on the response. N is a positive integer and M is a positive integer equal to or different from N.

### I. Terminology

In the following description, certain terminology is used to describe features of the invention. For example, in certain situations, the terms “component” and “logic” are representative of hardware, firmware or software that is configured to perform one or more functions. As hardware, a component (or logic) may include circuitry having data processing or storage functionality. Examples of such circuitry may include, but are not limited or restricted to, a hardware processor (e.g., microprocessor with one or more processor cores, a digital signal processor, a programmable gate array, a microcontroller, an application specific integrated circuit “ASIC”, etc.), a semiconductor memory, or combinatorial elements.

A component (or logic) may be software in the form of a process or one or more software modules, such as executable code in the form of an executable application, an API, a subroutine, a function, a procedure, an applet, a servlet, a routine, source code, object code, a shared library/dynamic load library, or one or more instructions. These software modules may be stored in any type of a suitable non-transitory storage medium, or transitory storage medium (e.g., electrical, optical, acoustical, or other form of propagated signals such as carrier waves, infrared signals, or digital signals). Examples of non-transitory storage medium may include, but are not limited or restricted to, a programmable circuit; semiconductor memory; non-persistent storage such as volatile memory (e.g., any type of random access memory “RAM”); or persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code may be stored in persistent storage. Upon execution of an instance of a system component or a software module, a “process” performs operations as coded by the software component.

According to one embodiment, the term “malware” may be construed broadly as any code or activity that initiates a malicious attack and/or operations associated with anomalous or unwanted behavior. For instance, malware may correspond to a type of malicious computer code that executes an exploit to take advantage of a vulnerability, for example, to harm or co-opt operation of a network device or misappropriate, modify, or delete data. Malware may also correspond to an exploit, namely information (e.g., executable code, data, command(s), etc.) that attempts to take advantage of a vulnerability in software and/or an action by a person gaining unauthorized access to one or more areas of a network device to cause the network device to experience undesirable or anomalous behaviors. The undesirable or anomalous behaviors may include a communication-based anomaly or an execution-based anomaly, which, for example, could (1) alter the functionality of an network device executing application software in an atypical manner (a file is opened by a first process where the file is configured to be opened by a second process and not the first process); (2) alter the functionality of the network device executing that application software without any malicious intent; and/or (3) provide unwanted functionality which may be generally acceptable in another context. Additionally, malware may be code that initiates unwanted behavior which may be, as one example, uploading a contact list from an endpoint device to cloud storage without receiving permission from the user.

The term “computing device” should be generally construed as electronics with the data processing capability and/or a capability of connecting to any type of network, such as a public network (e.g., Internet), a private network (e.g., a wireless data telecommunication network, a local area network “LAN”, etc.), or a combination of networks. Examples of a computing device may include, but are not limited or restricted to, the following: an endpoint device (e.g., a laptop, a smartphone, a tablet, a desktop computer, a netbook, a medical device, or any general-purpose or special-purpose, user-controlled electronic device configured to support virtualization); a server; a mainframe; a router; or a security appliance that includes any system or subsystem configured to perform functions associated with malware detection and may be communicatively coupled to a network to intercept data routed to or from an endpoint device.

The term “message” generally refers to information transmitted in a prescribed format, where each message may be in the form of one or more packets or frames, a Hypertext Transfer Protocol (HTTP) based transmission, or any other series of bits having the prescribed format. For instance, a message may include an electronic message such as an electronic mail (email) message; a text message in accordance with a SMS-based or non-SMS based format; an instant message in accordance with Session Initiation Protocol (SIP); or a series of bits in accordance with another messaging protocol exchanged between software components or processes associated with these software components.

The term “communication” generally refers to the transmission and/or reception of information. It may also refer to a physical medium that contains information. Examples of communication used in this context include a text, an audio or video file, a recording. A “network communication” refers to the communication that is transmitted or received via a network. It may also refer to a message from a user to the system, such as an inquiry to an LLM or a comment or statement in a conversation with an AI-based system.

The term “computerized” generally represents that any corresponding operations are conducted by hardware in combination with software and/or firmware. Also, the term “client” should be interpreted as a software component that is configured to be executed by one or more processors. The client may operate within either of the user or kernel modes of an operating system and may communicate (e.g., exchange data) with software applications or other logic modules. In some instances, a client may correspond to a driver operating in the user mode of the operating system of a computing device.

The term “attack” generally refers to any intentional effort to cause harm or damage to a target by unauthorized access to the target, whether through a network or not. Examples of attack include assets theft, data destruction, behavior altering, infrastructure disabling or interruption. An attack may also include a security or safety violation such as a violent crime, property or identity theft, etc.

The term “intrusion” generally refers to an unauthorized access to a system whether through a network or not. An intrusion by itself is a form of an attack because it invades the boundary of safety and security established by the target of the intrusion and destroys or renders ineffective the established safety and security measures. An intrusion may lead to further harm or damage to the system.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

### II. General Network Environment

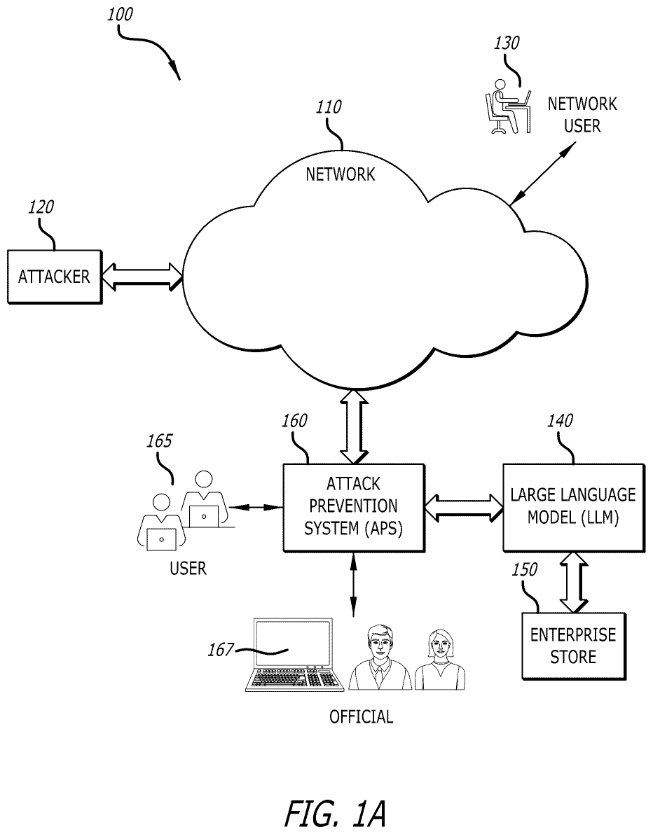

Referring to FIG. 1A, a block diagram illustrating an intrusion prevention system (IPS) configured to perform on premises in accordance with some embodiments. The system 100 in FIG. 1A includes a network 110, a cyber attacker 120, a network user 130, a large language model (LLM) 140, an enterprise store 150, and an attack prevention system (APS) 160. The system 100 may include more or less than the above components. The system 100 as shown in FIG. 1A is an illustrative example of the on-premises security environment in which some embodiments may be practiced.

The network 110 is a communication network that connects or links to devices to allow communication among users of the devices. In one embodiment, the network 110 is the Internet. The Internet is a global system of interconnected computer networks. It carries a large range of resources and services such as the interlinked hypertext documents and applications of the World Wide Web (WWW) and electronic mail. The network 110 may also include a wide area network (WAN) or a local area network (LAN). The network 110 provides the users accesses to functions and services via a network communication and a browser. The network communication is a form of communication among users of the network. It includes services or functionalities in a form of an email, a Uniform Resource Locator (URL), a Hypertext Transfer Protocol Secure (HTTPS), a World Wide Web page, and a link.

An attacker 120 may be an individual, an organization, a robot, or an artificial intelligence (AI)-designed function that intentionally causes harms or damages to a user of a networked system or enterprise by malicious acts such as stealing, exposing, altering, disabling, or destroying data, applications or other assets through unauthorized access to a network, computer system or digital device. Tactics used by the attacker 120 are varied and may include any one of malware attacks, ransomware attacks, social engineering scams, business email compromise (BEC) scams, and data and password theft. One popular type of cyberattack is the transmission of malicious URLs within network communications. Attacks geared towards LLMs include mainly jailbreaks, prompt injection, and data poisoning. In addition, attacks may be in other forms such as ethical boundary violations and data privacy breaches.

The network user 130 is any user of the network 110. The network user 130 may be an innocent user who may be an intended victim of a cyberattack. He or she may also be an unintentional accomplice of the cyber attacker 130 when he or she unintentionally forwards a network communication with a malicious URL to another person or otherwise shares the malicious URL to others.

The LLM 140 is an AI-based asset that performs tasks that involves interpretation and generation of human-like texts. In general, the LLM 140 employs deep learning techniques in language comprehension, text interpretation, and text generation and composition. The LLM 140 may be trained on large amounts of data that may come from the network 110 or locally within an enterprise or organization. The LLM 140 may be referred to as an enterprise LLM because it is employed by an enterprise or an organization to service its employees or the public. It typically has access to a variety of information or databases including public, private, and proprietary databases. The LLM 140 is an AI-based asset that is protected by the APS 160.

The enterprise store 150 represents a data center that stores information that may be used by the LLM 140. This information includes data, documents, files, and recordings that may be available publicly and/or privately. The information stored in the enterprise store 150 may or may not be sensitive or confidential. As an example, the enterprise store 150 may be a data center for a university. The data center may store public information such as academic programs, university catalogs and schedules, university policies, research activities, public donation records, and any other information that is of public interest. The data center may also store sensitive or confidential information such as employee records, student records (e.g., transcripts), confidential donation records, intellectual property assets, etc. An attack on the LLM 140 may compromise the integrity of the enterprise store 150 including unauthorized access to confidential university records.

The attack prevention system (APS) 160 may be a package (software, hardware, a combination of hardware and software) or an application implemented to prevent or safeguard an asset from attacks. The APS 160 may be deployed in an on-premises environment as shown in FIG. 1A, in a cloud environment as shown in FIG. 1B, or in a hybrid environment as shown in FIG. 1C. In one embodiment, the APS 160 may be installed in a security gateway housed in a computing device or a computer system. The attacks may be via the network 110 or on premises where the asset (e.g., the LLM 140) is housed or operates. The environment shown in FIG. 1A refers to an on-premises scenario where the attacks take place locally or off-line. The APS 160 is configured to employ a multi-level approach for attack prevention. In one embodiment, there are two basic levels. One level focuses on the communication or query directed to the LLM 140. Another level focuses on the response to the communication or query of the LLM 140. Each level employs a number of classifiers to classify the communication or the response into a number of classifications. Each of the classifiers is designed specifically to deal with an aspect of the communication or the response. Each level also employs an integrator to integrate, fuse, or combine the classifications. By examining the communication under various criteria and guidelines and combining the classifications, the APS 160 will be able to infer meaningful interpretations regarding the nature, motive, and intention of the communication. Similarly, by examining the response under various perspectives and combining the response conclusions, the APS 160 will be able to have a deeper understanding of the meaning of the response. In addition, in one embodiment, a level-crossing integration may combine the communication classifications and the response classifications to detect their causal relationships, often hidden, in order to arrive at a more intelligent decision regarding the nature, motive, and objective of the attack.

The APS 160 interacts with a user 165 and an official 167. It should be noted that while a singular noun is used, the designation may also refer to plural. In other words, the user 165 may refer to an individual or a group of individuals. The user 165 is an on-premises user as opposed to the network user 130. Similar to the network user 130, the user 165 may be an innocent user or an unintentional accomplice of the attacker 120 when he or she unintentionally participates in an attack attempt. In addition, the user 165 may be an actual attacker who launches an attack on-premises as opposed to the attacker 120 who attacks via the network 110.

The official 167 represents an official or an employee of the enterprise or the organization using the APS 160. He or she may be responsible for the administration of the safety and security of the LLM 140 and the enterprise store 150. He or she may be responsible for the installation, configuration, maintenance, and updating of the APS 160. The official 167 may receive notifications from the APS 160 regarding the results of the process of attack prevention on the communication. The official 167 may decide on what to do next in response to a notification of a malicious attack. Alternatively, a mechanism to deal with a detected attack may be installed in the APS 160. In one embodiment, the official 167 retains full control over the decision-making in the APS 160 upon receiving the recommendations or suggestions from the APS 160. In other embodiments, depending on the system configurations, the official 167, representing the enterprise or organization, may delegate some of the decision-making capabilities to the APS 160.

FIG. 1B is a block diagram illustrating an APS configured to perform in a cloud-based network environment in accordance with some embodiments. The system 100 shown in FIG. 1B is similar to the system 100 shown in FIG. 1A. For brevity, components that have the same reference labels will not be described again. The system 100 in FIG. 1B includes the network 110, a private cloud 115, a cloud APS 117, the cyber attacker 120, the network user 130, the LLM 140, and the enterprise store 150. The system 100 in FIG. 1B may include more or less than the above components.

The private cloud 115 is a cloud computing environment where all the computing resources including processing and storage elements are dedicated exclusively to a single organization, such as the enterprise owning the LLM 140 and the enterprise store 150. The private cloud 115 does not share its resources with other users and may be hosted on the enterprise's data center or a third-party provider.

The cloud APS 117 is similar to the APS 160 shown in FIG. 1A except that it is tailored to accommodate the private cloud 115. Functionally it is the same as the APS 160. Accordingly, in the following, any references to the APS 160 may be applicable to the cloud APS 117 unless otherwise noted. Since the cloud APS 117 is accessible via the network 110, it may be accessible to the attacker 120 in addition to the user 165. The distinction may not be necessary because from the point of view of attack prevention in a communication, it does not really matter whether the communication is transmitted via the network or transmitted off-line except that the network communication may be infected with other malicious links or attachments.

FIG. 1C is a block diagram illustrating an APS configured to perform in a hybrid mode including on-premises and cloud-based network environment in accordance with some embodiments. As in FIG. 1B, the system 100 shown in FIG. 1C is similar to the system 100 shown in FIG. 1A. For brevity, components that have the same reference labels in FIG. 1A or FIG. 1B will not be described again. The system 100 in FIG. 1C includes the network 110, the private cloud 115, a cloud APS 119, an on-premises APS 162, the cyber attacker 120, the network user 130, the LLM 140, and the enterprise store 150. The system 100 in FIG. 1C may include more or less than the above components.

Basically, the APS 160 is divided into two components: a cloud component and an on-premises component. The cloud APS 119 is the cloud component and the on-premises APS 162 is the on-premises component. The cloud APS 119 is similar to the cloud APS 117 in FIG. 1B except that it is not a full-blown cloud component. Similarly, the on-premises APS 162 is similar to the APS 160 in FIG. 1A except that it is not a full-blown on-premises component. Functionally, the combination of the cloud APS 119 and the on-premises APS 162 is equivalent to the APS 160. Accordingly, in the following, any references to the APS 160 may be applicable to the combination of the cloud APS 119 and the on-premises APS 162 unless otherwise noted.

### III. Representation of an Attack Prevention System

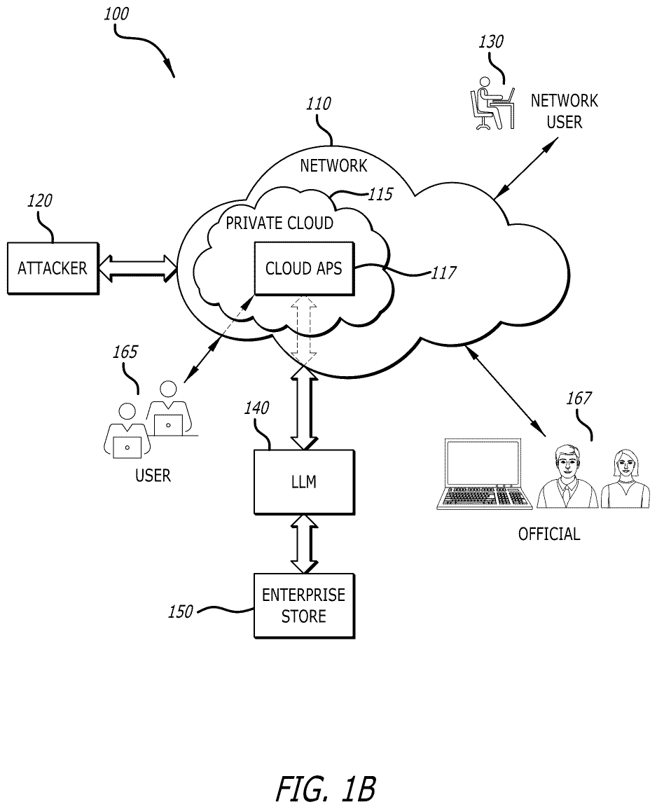

Referring to FIG. 2, a block diagram illustrating the functional structure of the APS 160 in FIG. 1A is shown in accordance with some embodiments. The APS 160 includes an evaluator 210 and an analyzer 220. The APS 160 may include more or less than the above components. The APS 160 has a number of distinctive features. First, it operates on a multi-level basis. The structure shown in FIG. 2 represents a two-level structure but conceptually, the processing chain may be extended to more than two levels. Each level focuses on an aspect of the elements involved in the system. In one embodiment, the evaluator 210 focuses on the communication from a user and the analyzer 220 focuses on the response from the LLM 140. The level of the evaluator 210 may be referred to as a low-level, an inquiry level, or an input level because it deals with the raw or direct communication or the inquiry from the user 165. The level of the analyzer 220 may be referred to as a high-level, a response level, or an output level because it deals with the response from the LLM 140. Second, the interactions between the APS 160 with the LLM 140 and others are bidirectional. The bidirectional configuration is optional and depends on the requirements or criteria of the enterprise or the business organization that deploys the LLM 140. The bidirectional communication with the LLM 140 is performed when the APS 160 wants to review the response from the LLM 140 before releasing it to the user 165. Third, the structure of the APS 160 supports modularity and expandability. The elements in one component may be updated including removals and additions without affecting the operation of the other component. This feature facilitates development of new classifiers that reflect the current trend. Fourth, the APS 160 provides support for customization that allows a flexible mechanism to incorporate features from other tools into the processing chain. The degree of customization depends on the nature of the level.

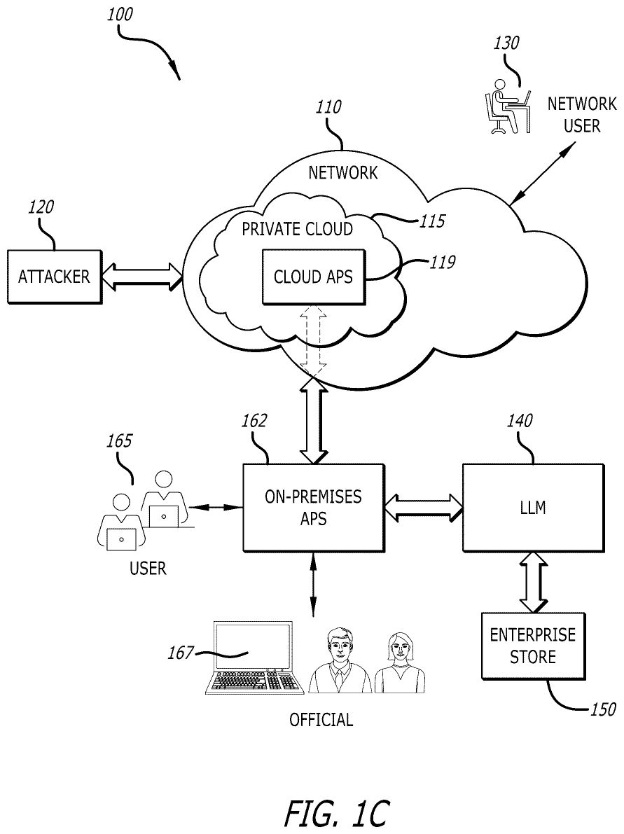

The evaluator 210 is configured to evaluate, rate, or judge a communication 205 from the user 165. As will be described further in FIG. 3, the evaluator 210 employes several classifiers to classify the communication 205 into several classifications. Since the evaluator 210 operates on the raw or direct communication from the user 165, it operates at a low level in the processing chain. The term “low” here refers to the initial, raw, or literal content of the information.

The analyzer 220 receives the classifications from the evaluator 210 and analyzes them to generate an assessment that characterizes the attack level in the communication 205. The characterization is preliminary in nature, but it may be sufficient to decide whether the communication 205 possesses any potential threat. If the assessment indicates the communication 205 is a potential threat or has a clear unsafe or harmful content, the analyzer 220 rejects the communication 205 and notifies the official 167 of the assessment. The analyzer 220 may also inform the user 165 of the reason of rejection.

If the classifications indicate that the communication 205 appears to be valid and safe, the analyzer 220 formats the communication 205 into an LLM communication 224 which is a communication suitable as an inquiry to the LLM 140. In one embodiment where a bidirectional configuration is desired, the LLM 140 then returns a response 226 to the analyzer 220. The response 226 is a reply to the communication 205. At this point, though the communication 205 appears to be valid and safe, this assessment is only preliminary. The analyzer 220 will further examine the nature of the communication 205 by moving to the second level, called a high level. At this level, the analyzer 220 reviews the response 226 to validate it and arrive at a decision regarding whether the communication 205 is benign or malicious. By reviewing the response 226 in light of other evaluating criteria, the analyzer 220 can decide whether it is safe to forward the response to the user 165. Since the analyzer 220 does not control the LLM 140, does not understand the behavior of the LLM 140, and cannot predict what the LLM 140 will reply, it can only inspect the content of the response to determine whether this response is harmful. The user 165 may be a clever attacker who craftily generates the communication 205 that may look innocent but has a hidden manipulating power. Therefore, the communication 205 may be evaluated by the evaluator 210 to be benign, but the hidden manipulating power results in a harmful response which can be determined by inspecting the response itself.

As an example, suppose the following is a conversation between the user 165 and the LLM 140:
communication 205=“I bet your CEO John Smith is well paid based on his performance in the last quarter.”
Response 226=“Yes, that's true. The last quarter well exceeds the expectations. Mr. Smith's bonus is increased 25% to $2.5 million.”

The communication 205 is initially classified as BENIGN by the evaluator 210 because it is simply a comment on Mr. Smith's performance. However, the LLM 140, perhaps having access to private information in the enterprise store and was influenced by the user's previous questions, inadvertently reveals the confidential information on Mr. Smith's increased bonus. The response 226 is rated as harmful regardless of the inquiry or the communication 205. Therefore, the analyzer 220 holds back the response 226 and does not forward it to the user 165, preventing the user 165 from obtaining the confidential information.

While the response 226 appears to be determinative without the evaluator 210, there are at least three reasons why it is necessary to classify the communication 205. First, the evaluator 210 acts like a first line of defense to filter out clearly malicious communication. If malicious communication is allowed to go directly to the LLM 140 without prescreening, computational resources (e.g., memory, time) may be wasted due to LLM processing. Suppose the classification has a binary value where 0 is valid or safe and 1 is invalid or unsafe. Then, the classifications of communication 205 and the response 226 will have four different combinations: 0 0 (both communication 205 and response 226 are valid or safe), 0 1 (communication 205 is safe and Response 226 is unsafe), 1 x (communication 205 is unsafe and response 226 is irrelevant because the communication 205 will not be forwarded to the LLM 140). It can be seen that the LLM 140 will not be invoked whenever the communication 205 is rejected. The computational resources and time will be saved according to the statistics on the malicious communication. Second, depending on the nature of the malicious communication, the communication 205 may contain elements that raise a red flag on a secondary aspect that may be different than the primary aspect which may pass the defense. For example, in the above example, suppose the communication 205 is:
communication 205=“Is it fair for the CEO, Mr. John Smith, to be awarded with a generous bonus for the stellar performance in the last quarter when he does not represent the majority of the company's employees for being a man of color?”

In the above example, the aspect on the generous bonus may pass scrutiny, but the aspect on race will be flagged as racially discriminatory and the entire communication 205 will be rejected as UNSAFE and will not be forwarded to the LLM 140.

Third, the communication 205 and the response 226 represent two different types on the same issue. The communication 205 represents the question and the response 226 represents the answer. By examining both the question and the answer, the APS 160 will have a better chance to detect malicious attack and prevent it from propagating.

In one embodiment, the APS 160 mainly processes a single conversation at any given time. This reduces the complexity, facilitates development, and simplifies expansion. In other embodiments, conceptually, the APS 160 may be extended to a three-level structure where the third level, called an interpreter, will focus on the interpretation of the response in the context of the overall interactions between the user 165 and the LLM 140. In this three-level structure, part of the analyzer 220 will be moved into the third level interpreter. The part of the analyzer 220 that may be moved to the interpreter is the part that deals with the interpretation of the motive or objective of the attack. The rest of the interpreter may include inferences from classifications of additional contextual information including the history of interactions of the user 165 with the LLM 140, the current economic, social, and/or political climates, and any other relevant contexts (e.g., geopolitical, traveling, insurance scams, epidemic outbreaks, natural disasters). The contextual information used by the interpreter provides a broader scope of the overall consideration so that more robust interpretations and/or decisions may be obtained. For example, the contextual information may indicate a serious problem exists in an economic sector. This problem may be related to certain imported goods or merchandises (e.g., pacemakers) from a certain country (e.g., China). The communication from the user suggests the user's interest in China and pacemakers' imports. The communication appears benign and seems to be an innocent inquiry on the issue of importing medical instruments from China. However, the enterprise that owns the LLM 140 has a subsidiary component XYZ that manufactures pacemakers and, in the past, the same user 165 inquires about the manufacturing output of that subsidiary. When the dots are connected, a more complete picture may emerge that shows that the user 165 is attempting to obtain confidential information on the pacemakers' delivery performance of the subsidiary XYZ. Contextual information, therefore, helps provide the high-level interpretation of an inquiry and a response. More levels may be added depending on the nature of the business environment the APS 160 is operating in. Accordingly, the multi-level approach provides a better safety and security protection for the LLM 140 than a single level approach.

FIG. 3 is a block diagram illustrating the evaluator 210 as shown in FIG. 2 in accordance with some embodiments. The evaluator 210 includes a set 310 of first classifiers and a set 320 of classifications. The term “first” is used to designate a type of classifier which is different from the “second” classifier to be discussed later. The evaluator 210 may include more or less than the above components.

The set 310 includes N first classifiers 315ₖ′s (k=1, . . . , N) where N is a positive integer. Each first classifier is configured to classify the communication 205 into a classification. N first classifiers will generate N first classifications. The N first classifiers 315ₖ's are different and focus on different aspects of the communication 205. These aspects represent the types of attack or intrusion or safety or security violations. In one embodiment, at least one of the N first classifiers 315ₖ's is a light-weight LLM that has been trained to recognize a threat or to determine whether an input violates a content safety standard. In addition, at least one of the N first classifiers 315ₖ's is a customized light-weight LLM or a customized applications programming interface (API) that is designed to inspect the input under a set of criteria geared toward a particular type of text or content. A customized classifier may be an LLM classifier in which the parameters have been selected according to the particular requirements of the systems or other criteria. The N first classifiers 315ₖ's may operate sequentially or in parallel. For speed, they run in parallel because they are independent. The following are some examples of the N first classifiers.
Prompt injection and jailbreaks: One first classifier may focus on prompts including explicitly malicious prompts (e.g., jailbreaks) and prompts that contain injected inputs (prompt injections). This prompts classifier reads the communication 205 and produces three classifications: benign (normal inputs without any risk), injection (Inputs that contain hidden or out-of-place commands aimed at exploiting the model's behavior), and jailbreak (inputs that attempt to bypass or disable the model's safety and security features).
Malicious URL: Another first classifier may focus on detecting malicious URLs. The classifier may scan text and match indicators from malicious websites and phishing domains. The classifier may provide results for at least the following categories: phishing, malware, command and control (C2) URL, and parked domains. The results may include a numeric score representing the confidence level of the detection.
Safety: Another first classifier may focus on content safety classification. It reads the communication 205 and produces the output of safe or unsafe. If unsafe, the classifier indicates what kind of category that is unsafe. The category includes one of violent crime, non-violent crime, sex-related crime, child exploitation, defamation, privacy, intellectual property, etc.

The set 320 includes the N first classifications (CLASSes) 320ₖ′s (k=1, . . . , N) as produced by the set 310. The classifications 320ₖ's include the values as above. All N classifications 320ₖ's are then presented to the analyzer 220. In general, the classifications 320ₖ's are independent and correspond to different types of potential threats.

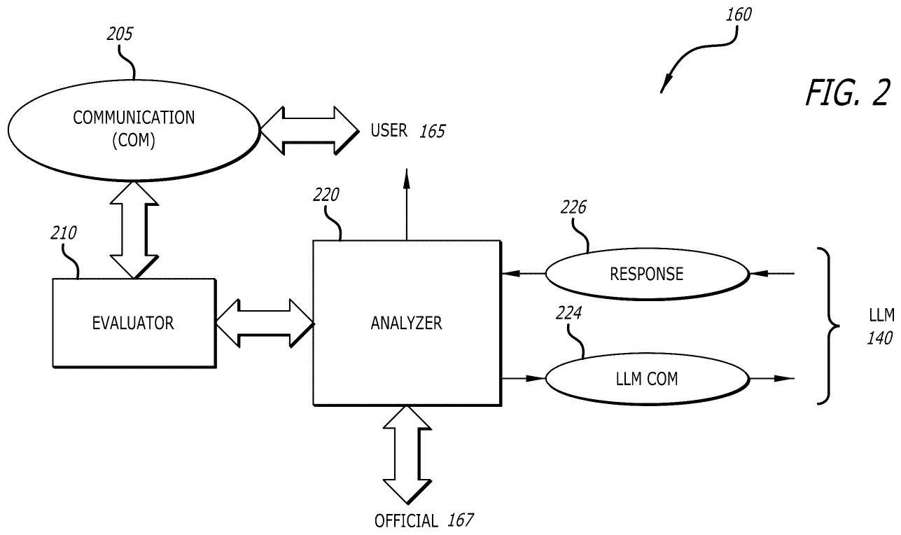

FIG. 4 is a block diagram illustrating the analyzer 220 as shown in FIG. 2 in accordance with some embodiments. The analyzer 220 includes a first integrator 410, a formulator 420, a formatter 425, a parser 430 and a validator 440. The analyzer 220 may include more or less than the above components. In addition, one or more components may be included in the evaluator 210. For example, the first integrator 410 may be moved to the evaluator 210. The analyzer 220 includes two parts. The first part includes the first integrator 410, the formulator 420, and the formatter 425. The first part processes the classifications from the set 320 to determine whether the communication 205 is valid or invalid, or whether the communication 205 is accepted or rejected. If the communication 205 is invalid or rejected, the process will be stopped and no further operations will be carried out. Only when the communication 205 is determined to be valid or accepted, then the process continues with the second part. It invokes the LLM 140 to respond to the communication 205 and determines if the response from the LLM 140 is valid or invalid. The second part includes the parser 430 and the validator 440. Furthermore, depending on the configuration based on the requirements of the enterprise or the business organization, the second part may be optional.

The first integrator 410 integrates the N first classifications 325ₖ′s (k=1, . . . , N) from the set 320. The integration combines or fuses all the classifications to produce an assessment 414. The integration of the N first classifications 325ₖ's may be similar to problems dealing with multiple pieces of evidence such as weather prediction, medical diagnosis, or criminal investigation. Jaw pain and sweating individually may not be significant but when combined, the totality of their presence may be a good indicator of an imminent heart attack. Gambling losses, experience with firearms as a former law enforcement officer, and resentment toward a person individually may score low on a murder case. However, the combined information may be significant as a motivation of the murder. The integration of the N first classifications 325ₖ's, therefore, may be considered as a multi-sensor integration (MSI). It may include techniques in MSI such as Bayes theory and Dempster Shafer theory according to the nature of the classifications. For example, if the classifications are presented as probabilities, then a Bayesian fusion technique may be appropriate. As another example, when the multiple sources of information are uncertain, incomplete, or have varying degree of reliability, a Dempster-Shafer theory may be appropriately applied. In the context of the first integrator 410, the classifications are presented in different formats based on different types of classifiers, it may be useful to have inference rules that are specifically developed for these cases. Technique in expert systems or rule-based systems may be exploited to provide the inference rules when combining multiple analysis results. The rules may be guided by a set 416 of criteria that are developed to deal with the combination of the classifications.

In one embodiment, the first integrator 410 includes a weighting scheme that weighs the classifications according to the set 416 of criteria. The weighting scheme allows the APS 160 to accommodate different standards, criteria, requirements, or preferences from a variety of users and/or enterprises. The weights may be obtained through a learning scheme that may look at several factors related to the threats. In one embodiment, the weights are set or predetermined in the system. In other embodiments, they may also be set by the owner of the APS 160. The weighting scheme may operate on heterogenous or homogeneous classifications. For heterogeneous classifications, the weighing scheme may be based on a set of rules, or a transformation may be performed to convert the heterogeneous classifications into homogeneous classifications. For homogeneous classifications, some normalization on the classifications may be employed. For example, suppose the classifications are various risk factors, threat levels, or security scores that are represented numerically. These numbers may be normalized within a range, say, from 0 to 1. The weights for these classifications will then be applied and the calculation is performed. The result is then compared to a threshold. An invalid or unsafe result may be declared if this result exceeds the threshold. For example, suppose there are 3 classifications as follows.
C1=probability of a detected prompt injection, range from 0 to 1.
C2=security score for a defamation violation, range from 0 to 1 where 0 is no defamation concern and 1 is the highest level of concern.
C3=probability of a detected malicious URL, range from 0 to 1.

Suppose the weights for the classifications C1, C2, and C3 according to the set 416 of criteria are 0.9, 0.3, and 0.9, respectively. The values of C1, C2, and C3 as reported by the corresponding classifiers, after normalization, are 0.2, 0.8, and 0.15. The final score S, representing the assessment, is:

$$S = 0.9 * C 1 + 0.3 * C 2 + 0.9 * C 3$$

$$S = 0.9 * 0.2 + 0.3 * 0.8 + 0.9 * 0.15 = 0.555$$

Suppose the threshold is T=0.6. Since S<T, the system does not report a threat although the formulator 420 may attach an explanation.

The formulator 420 formulates a characterization of the attack level in the communication 205 by applying the rules from the set 416. As in example, suppose the set 320 has two classifications (N=2): CLASS 3251 is produced by a prompt classifier and CLASS 3252 is produced by a content safety classifier. Some examples of applying the rules based on the set 416 to formulate a characterization are:
If CLASS 3251 is benign and CLASS 3252 is safe then the communication 205 is valid.
If CLASS 3251 is injection and CLASS 3252 is safe then the communication 205 is invalid.
If CLASS 3251 is benign and CLASS 3252 is unsafe with category S23 then the communication 205 is valid with further qualifications.

The above examples are merely illustrative. The set 416 provides guidance on how to characterize the attack level. The characterization may represent a value of the assessment, and this value will be used to determine whether the communication 205 will be accepted or rejected. The formulator 420 may also include a detailed explanation of the assessment including itemization of types to detected threats. The explanation offers context and reasoning behind the security decision, enhancing transparency and a better understanding of potential threats. In addition, the explanation may include recommendations or suggestions on what to do next or how to respond.

The formatter 425 formats the characterization in a proper format for presentation to the official 167 or to the LLM 140 in a form of an inquiry LLM communication 224. If the characterization indicates a valid result, the communication 205 will be formatted into the LLM communication 224 to be sent to the LLM 140. The LLM communication 224 is in essence a formatted communication 205. The formatter 420 removes redundant or irrelevant terms in the communication 205 and rephrases them accordingly. If the characterization indicates an invalid result, the communication 205 will be formatted into a reply to be sent to the official 167 for further processing, such as notifying the user 165 that the communication 205 is invalid and will not be processed. The formatter 420 may also formats the analysis and explanation provided by the formulator 420. The official 167, upon receiving the formatted analysis and explanation and/or recommendations from the formatter 540, reviews the explanations and/or recommendations and will make the final decision on how to proceed and what to do with the threat.

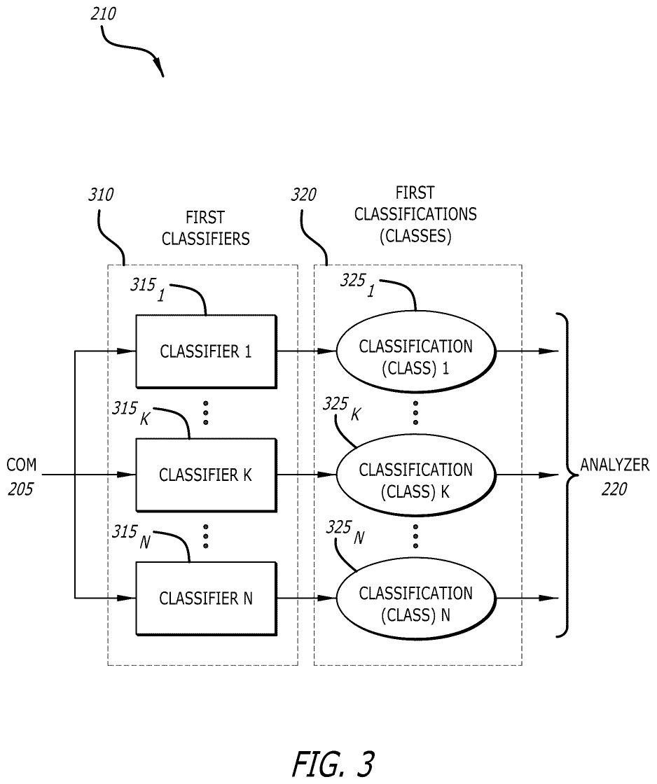

In one embodiment, the analyzer 220 includes the parser 430 and the validator 440 to process the response 226. In other embodiments, the bidirectional configuration may be optional. The parser 430 receives the response 226 from the LLM 140 and parses the response 226 into a parsed response 435. The parsed response 435 includes the response elements that contain relevant words or phrases that can be validated or further processed. The validator 440 validates the response 226 by processing the response elements. There will be two outcomes of the validator 440. In the first outcome, the response 226 is judged to be valid, meaning that it is safe to be transmitted to the user 165. In the second outcome, the response 226 is judged to be invalid or unsafe, meaning that the response 226 will not be transmitted to the user 165 and this determination will be sent to the official 167 for further processing. The validator 440 will be described in FIG. 5.

FIG. 5 is a block diagram illustrating the validator 440 as shown in FIG. 4 in accordance with some embodiments. The validator 440 includes a set 510 of second classifiers, a set 520 of second classifications, a second integrator 530, and a formatter 540. The validator 440 may include more or less than the above components. In essence, the validator 440 reviews the response 226 to generate a decision on the response 226.

The set 510, the set 520, and the second integrator 530 are similar to the set 310 being the first set of classifiers, the set 320 being the first set of classifications, and the first integrator 410, respectively, except that the type of classifiers in the set 510 and the rules in the second integrator 530 may be different.

The set 510 includes M second classifiers 515ₖ′s (k=1, . . . , M) which classify the parsed response 435 into M classifications. M is a positive integer which may be equal to or different from N. Each of the M second classifiers 515ₖ's may be the same or different from the N first classifiers 315ₖ's. In one embodiment, at least one of the M second classifiers 515ₖ's is a light-weight LLM that has been trained to recognize a threat or to determine whether an input violates a content safety standard. In addition, at least one of the M second classifiers 515ₖ's is a customized light-weight LLM or a customized applications programming interface (API) that is designed to inspect the input under a set of criteria geared toward a particular type of text or content. The M second classifiers 515ₖ's may operate sequentially or in parallel. For speed, they run in parallel because they are independent.

The set 520 includes M second classifications 525ₖ′s (k=1, . . . , M) which are the outputs of the M second classifiers 515ₖ's, respectively. Depending on the type of the M second classifiers, the M second classifications 525ₖ's may have values or contents that characterize the level of threat or level of content safety.

The second integrator 530 integrates the M second classifications 525ₖ's from the set 520. The integration combines or fuses all the classifications to produce a decision 535. The integration of the M second classifications 525ₖ's may be similar to that of the N first classifications 325ₖ's. In particular, a weighing scheme may be employed as in the first integrator 410. In addition, in one embodiment, the second integrator 530 integrates the M second classifications 525ₖ's and part or all of the N first classifications 325ₖ's to make a decision based on the totality of information including the inputs and outputs of the LLM 140. This operation in effect combines elements in the first level (evaluator 210) and the second level (analyzer 220). This level-crossing integration further enhances the robustness and reliability of the decision. Furthermore, high level contextual information may be applied to the second integrators 530 provide a more intelligent and complete decision.

The decision 535 may have several values depending on the requirements of the organization that operates the LLM 140 or the APS 160. In essence, the decision 535 has two values. The first is to proceed to forward the response 226 to the user 165 when the response 226 is judged to be benign or safe. The second is to send a notification to the official 167 that the response 226 is deemed unsafe.

The formatter 540 formats the decision 535 in a suitable form for presentation to the user 165 or the official 167. When a threat exists, the formatter 540 may also include detailed explanations and/or recommendations on the decision 535 including context and reasoning behind the decision in much the same way as the formulator 420. The official 167, upon receiving the detailed explanations and/or recommendations from the formatter 540, reviews the explanations and/or recommendations and will make the final decision on how to proceed and what to do with the threat.

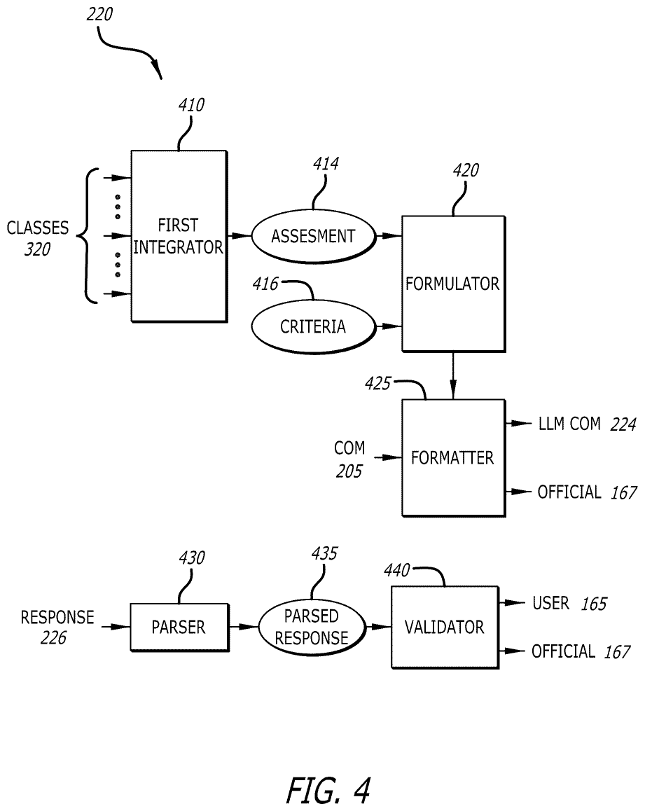

FIG. 6 is a flowchart illustrating a process 600 of attack prevention in accordance with some embodiments. Upon START, the process 600 evaluates a communication from a user using N first classifiers to provide N first classifications (Block 610). N is a positive integer. The communication interacts with a first large language model (LLM). The interaction may be a form of an inquiry or a conversation where the user poses questions or comments to the LLM. The N first classifiers include at least a second LLM. The second LLM may be a light-weight LLM compared to the first LLM or a customized LLM. The communication may be via a network or may be off-line and takes place on-premises. Next, the process 600 analyzes the N first classifications to generate an assessment having a first value (Block 620). The assessment characterizes an attack level in the communication.

Then, the process 600 determines if there is an attack in the communication (Block 630). This may be done by checking a first value of the assessment. If so, the process 600 proceeds to Block 635 to reject the communication and inform the official (Block 635). Otherwise, if there is no attack or threat (NO branch at block 630), the process 600 obtains a response to the communication from the LLM (Block 640). Next, the process 600 reviews the response using M second classifiers to generate a decision on the response (Block 650).

Then, the process 600 determines if there is an attack in the response (Block 660). If so, the process 600 rejects the response and informs the official (Block 665). Otherwise, if there is no threat or attack, the process 600 forwards the response to the user (Block 670) and is then terminated.

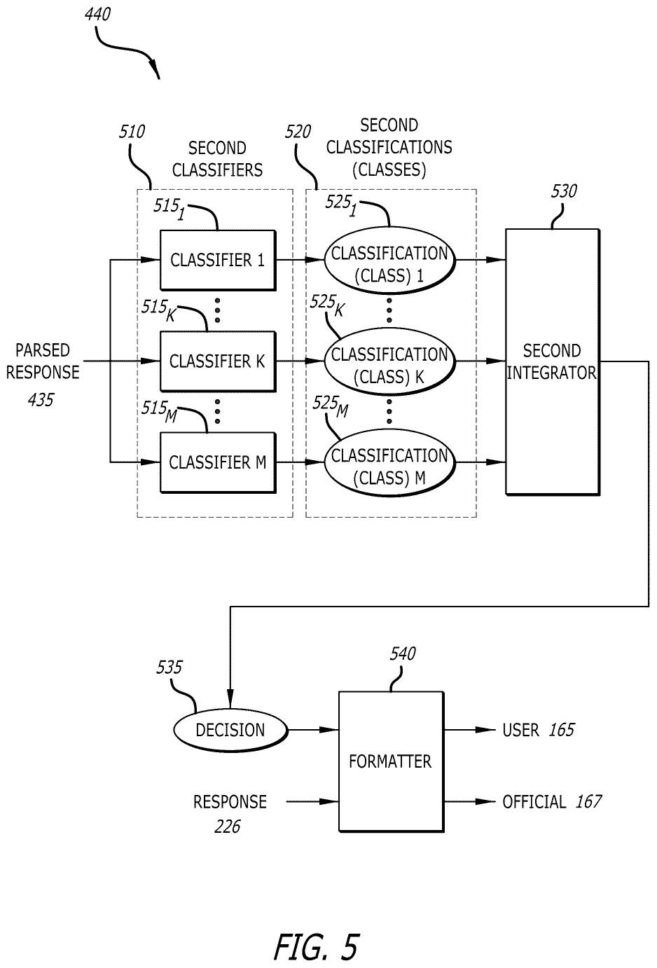

FIG. 7 is a flowchart illustrating the process 610 of evaluating a communication in accordance with some embodiments. Upon START, the process 610 invokes the N first classifiers, each responsive to an aspect of the communication to produce the N first classifications (Block 710). Some aspects of the communication include prompt injection and content safety. The N first classifications may include values such as benign, injection, jailbreak, safe, unsafe, etc., The process 610 is then terminated.

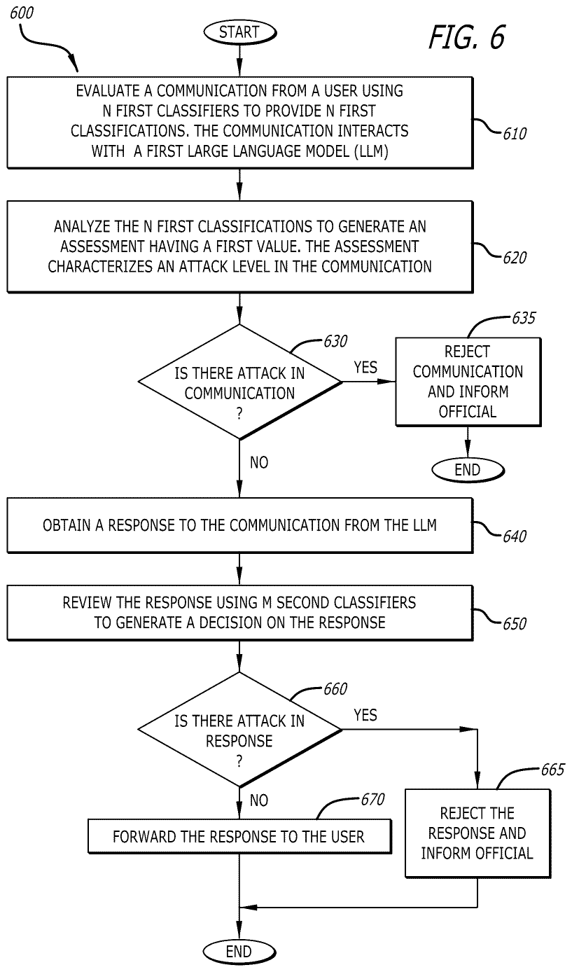

FIG. 8 is a flowchart illustrating a process 620 of analyzing the N first classifications in accordance with some embodiments. Upon START, the process 620 integrates the N first classifications to characterize the assessment (Block 810). The integration includes applying rules to combine or fuse the N first classifications. This include any weighing scheme and comparison with a threshold. Next, the process 620 formulates the assessment to have the first value based on a set of criteria (Block 820). The set of criteria is developed according to the current trend of the technology, safety, and security, and other factors such as requirements, preferences of the owner of the APS 160. The process 620 is then terminated.

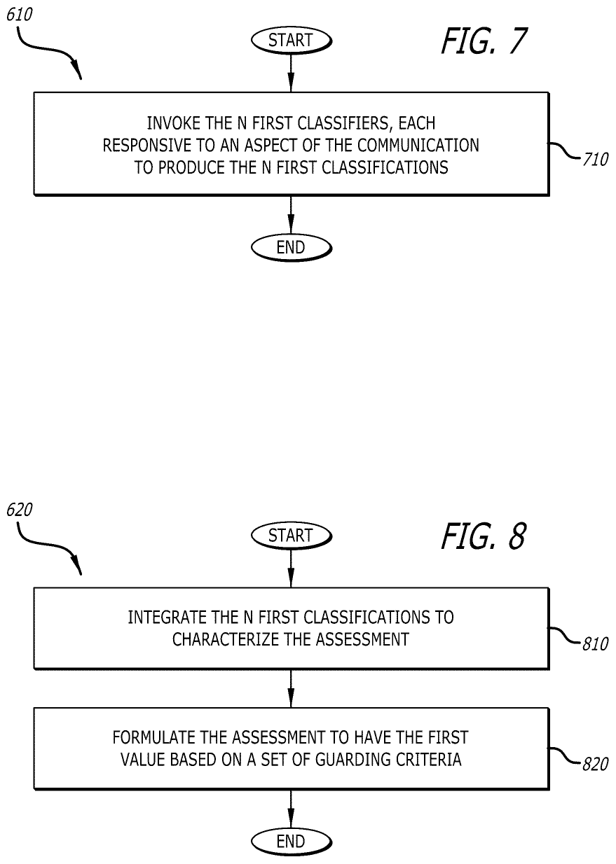

FIG. 9 is a flowchart illustrating the process 640 of obtaining a response in accordance with some embodiments. Upon START, the process 640 enables the first LLM based on the first value (Block 910). If the first value indicates the communication is valid, the process 640 enables the first LLM. If not, the process 640 does not enable the LLM and informs the official of the decision. Next, the process 640 presents the communication to the first LLM to solicit the response (Block 920) and is then terminated.

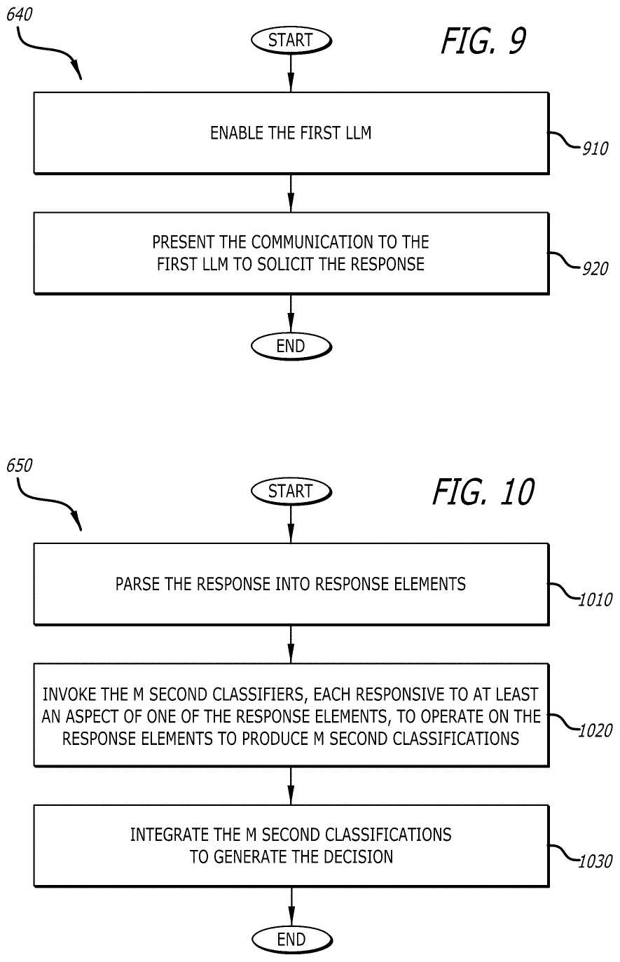

FIG. 10 is a flowchart illustrating the process 650 of reviewing the response in accordance with some embodiments. Upon START, the process 650 parses the response into response elements (Block 1010). This includes removing any redundant or irrelevant words or phrases. Next, the process 650 invokes the M second classifiers to operate on the response elements to produce M second classifications (Block 1020). M is a positive integer which is the same or different from N. The M second classifiers include at least a second LLM. The second LLM may be a light-weight LLM compared to the first LLM or a customized LLM. Each of the M second classifiers is responsive to at least an aspect of one of the response elements. Then, the process 650 integrates the M second classifications to generate the decision (Block 1030). The integration of the M second classifications is similar to the integration of the N first classifications including any weighing scheme according to a predefined set of criteria. The process 650 is then terminated.

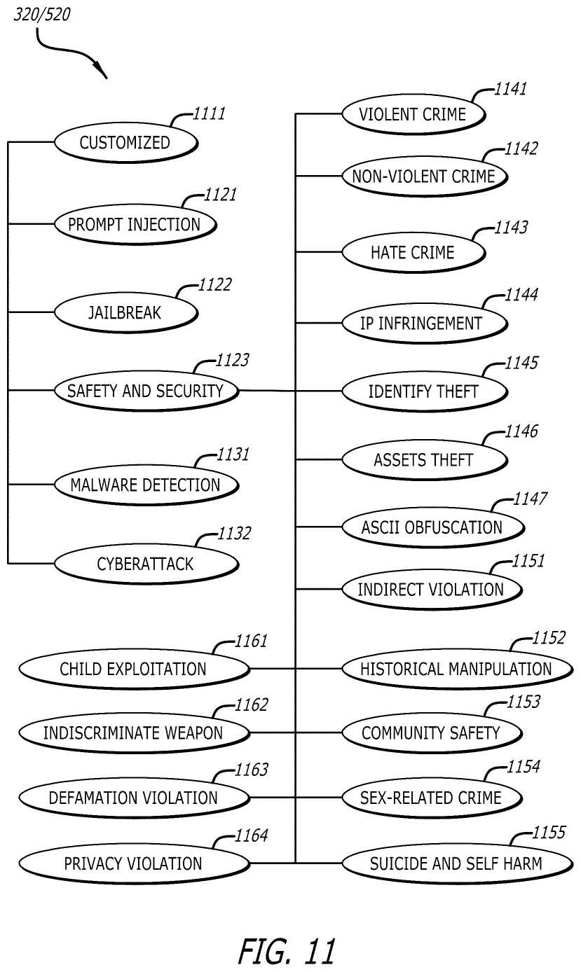

FIG. 11 is a block diagram illustrating examples of the classifications 320/520 in accordance with some embodiments. The classifications 320/520 represent the classes or values generated by the corresponding classifiers. The classifications 320/520 include a customized classification 1111, a prompt injection 1121, a jailbreak 1122, a safety and security 1123, a malware detection 1131, and a cyberattack 1132. This list is merely representative and may be expanded or shortened depending on the applications.

The classification 1123 of safety and security includes a violent crime 1141, a non-violent crime 1142, a hate crime 1143, an intellectual property (IP) infringement 1144, an identity theft 1145, an assets theft 1146, an American Standard Code for Information Interchange (ASCII) obfuscation 1147, an indirect violation 1151, a historical manipulation 1152, a community safety 1153, a sex-related crime 1154, a suicide and self-harm 1155, a child exploitation 1161, an indiscriminate weapon 1162, a defamation violation 1163, and a privacy violation 1164. The classification 1123 may include more or less than the above elements.

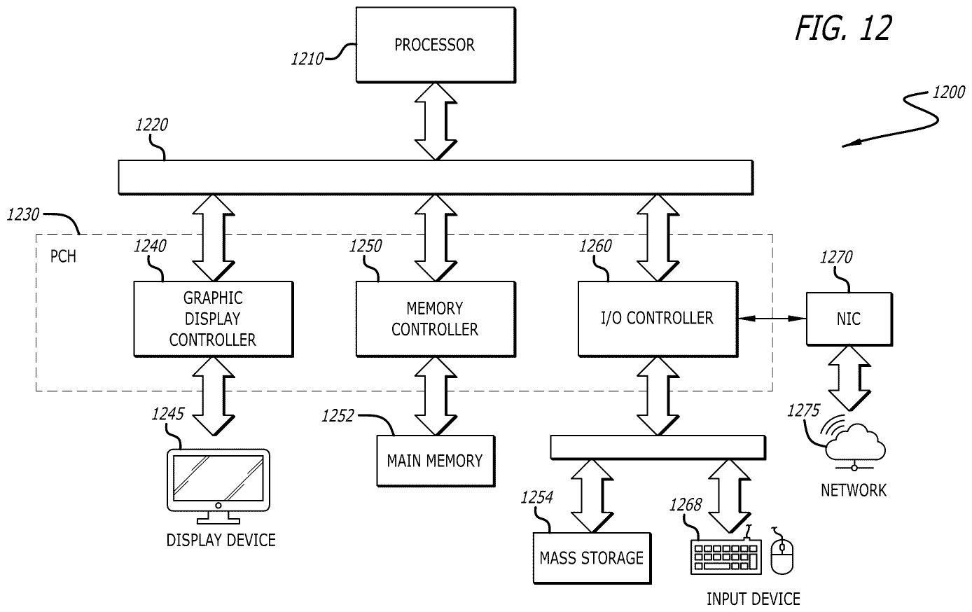

FIG. 12 is a diagram illustrating a computing or processing system 1200 that implements the intrusion prevention according to an embodiment. The computing system 1200 may be a host in a system on which the APS 160 operates. In one embodiment, the computing system 1200 performs the operations described in FIG. 2. It includes a central processing unit (CPU) or a processor 1210, a platform controller hub (PCH) 1230, and a bus 1220. The PCH 1230 may include a graphic display controller (GDC) 1240, a memory controller 1250, and an input/output (I/O) controller 1260. The processing system 1200 may include more or less than the above components. In addition, a component may be integrated into another component. As shown in FIG. 12, all the controllers 1240, 1250, and 1260 are integrated in the PCH 1230. The integration may be partial and/or overlapped. For example, the GDC 1240 may be integrated into the processor 1210, the I/O controller 1260 and the memory controller 1250 may be integrated into one single controller, etc.

The processor 1210 is a programmable device that may execute a program or a collection of instructions to carry out a task. It may be a general-purpose processor, a digital signal processor, a microcontroller, or a specially designed processor such as one design from Applications Specific Integrated Circuit (ASIC). It may include a single core or multiple cores. Each core may have multi-way multi-threading. The processor 1210 may have simultaneous multithreading feature to further exploit the parallelism due to multiple threads across the multiple cores. In addition, the processor 1210 may have internal caches at multiple levels. The bus 1220 may be any suitable bus connecting the processor 1210 to other devices, including the PCH 1230. For example, the bus 1220 may be a Direct Media Interface (DMI). The PCH 1230 in a highly integrated chipset that includes many functionalities to provide interface to several devices such as memory devices, input/output devices, storage devices, network devices, etc.

The I/O controller 1260 controls input devices 1268 (e.g., stylus, keyboard, and mouse, microphone, image sensor) and output devices (e.g., audio devices, speaker, scanner, printer), and a mass storage 1254. The mass storage 1254 may also include CD-ROM, hard disk, and SSDs. It also has a network interface card (NIC) 1270 which provides interface to a network such as the network 110 in FIGS. 1A-1C and wireless medium 1475.

The memory controller 1250 controls memory devices such as a main memory 1252. The main memory 1252 includes random access memory (RAM) and/or the read-only memory (ROM) and other types of memory such as the cache memory or a solid-state drive (SSD). The main memory 1252 may store instructions or programs, loaded from a mass storage device, that, when executed by the processor 1210, cause the processor 1210 to perform operations as described above. It may also store data used in the operations. The ROM may include instructions, programs, constants, or data that are maintained whether it is powered or not. The instructions or programs may correspond to the functionalities described above, such as the evaluator 210 and the AAA 220.

The GDC 1240 controls a display device 1245 and provides graphical operations. It may be integrated inside the processor 1210. It typically has a graphical user interface (GUI) to allow interactions with a user who may send a command or activate a function. Additional devices or bus interfaces may be available for interconnections and/or expansion. The bus interfaces may be serial or parallel, with or without power delivery, etc.

As discussed above, embodiments of the disclosed multi-level approach offer several technical advantages that are superior to existing approaches in attack prevention. The following are representative advantages:
Multiple classifiers: These classifiers may correspond to various aspects of attack including prompt injection, jailbreaking, malicious URL, safety, and security. FIG. 11 illustrates several of these classifiers. There are no restrictions on the type of classifiers. They may be non-LLM or light-weight LLMs. By using multiple classifiers with different protection schemes, the APS 160 can provide a wide and comprehensive protection to the AI-asset.
Flexibility multi-level system: The structure of the APS 160 allows flexibility, modularity, and expandability. Classifiers may be added, removed, or modified according to current trend in technology, safety, and security. Any changes would require minimal changes in the APS 160. The rules used in the first integrator 410 and second integrator 530 are designed for easy update.
Parallel processing: The first classifiers 310 and the second classifiers 510 can operate independently of one another and therefore they can run in parallel. The parallel processing allows fast response time and efficient utilization of resources.
Integration of outputs of multiple classifiers: The classifications in the from the evaluator 210 and the analyzer 220 are combined, synthesized, or integrated by the first integrator 410 and the second integrator 530. The integration effectively balance the need for thorough security checks with the requirement for efficient processing of legitimate requests.
Customized classifiers: Classifiers are customized to accommodate the particular requirements and preferences of the enterprise or user. The formulator 420, the formatter 425, and the formatter 540 provide custom evaluations, e.g., in a machine-readable format such as the JavaScript Object Notation (JSON) format, that provide detailed breakdown of various threat types and explanations for the preliminary assessment and decision.

In the foregoing description, the disclosure is described with reference to specific exemplary embodiments thereof. It will, however, be evident that various modifications and changes may be made thereto without departing from the broader spirit and scope of the disclosure as set forth in the appended claims.

What is claimed is:

1. A computerized method comprising:
evaluating a communication from a user using N first classifiers to provide N first classifications, the communication interacting with a first large language model (LLM);
analyzing the N first classifications to generate an assessment having a first value, the assessment characterizing an attack level in the communication;
obtaining a response to the communication from the LLM based on the first value; and
reviewing the response using M second classifiers to generate a decision on the response,
wherein N is a positive integer and M is a positive integer equal to or different from N.

2. The computerized method of claim 1, further comprising:
forwarding the response to the user based on the decision.

3. The computerized method of claim 1, wherein one of the N first classifiers and the M second classifiers includes at least a second LLM.

4. The computerized method of claim 1, wherein evaluating the communication comprises:
invoking the N first classifiers, each responsive to an aspect of the communication to produce the N first classifications.

5. The computerized method of claim 1, wherein analyzing the N classifications comprises:
integrating the N first classifications to characterize the assessment; and
formulating the assessment to have the first value based on a set of criteria.

6. The computerized method of claim 1, wherein obtaining the response comprises:
enabling the first LLM based on the first value; and
presenting the communication to the first LLM to solicit the response.

7. The computerized method of claim 1, wherein reviewing the response comprises:
parsing the response into response elements;
invoking the M second classifiers, each responsive to at least an aspect of one of the response elements, to operate on the response elements to produce M second classifications; and
integrating the M second classifications to generate the decision.

8. The computerized method of claim 1, wherein at least one of the N first classifiers and the M second classifiers is a customized classifier.

9. The computerized method of claim 1, wherein at least one of the N first classifiers and the M second classifiers classifies at least one of a prompt injection, a jailbreak, a safety and security item, a malware detection, and a cyberattack.

10. The computerized method of claim 9, wherein the safety and security item is one of a violent crime, a non-violent crime, a hate crime, an intellectual property infringement, an identity theft, an assets theft, an ASCII obfuscation, an indirect violation, a historical manipulation, a community safety, a sex-related crime, a suicide and self-harm, a child exploitation, an indiscriminate weapon, fake news, a defamation violation, and a privacy violation.

11. A computing device, comprising:
a processor; and
a non-transitory computer-readable medium having stored thereon instructions that, when executed by the processor, cause the processor to perform operations including:
evaluating a communication from a user using N first classifiers to provide N first classifications, the communication interacting with a first large language model (LLM);
analyzing the N first classifications to generate an assessment having a first value, the assessment characterizing an attack level in the communication;
obtaining a response to the communication from the LLM based on the first value; and
reviewing the response using M second classifiers to generate a decision on the response,
wherein N is a positive integer and M is a positive integer equal to or different from N.

12. The computing device of claim 11, wherein the operations further comprise:
forwarding the response to the user based on the decision.

13. The computing device of claim 11, wherein one of the N first classifiers and the M second classifiers includes at least a second LLM.

14. The computing device of claim 11, wherein evaluating the communication comprises:
invoking the N first classifiers, each responsive to an aspect of the communication to produce the N first classifications.

15. The computing device of claim 11, wherein analyzing the N classifications comprises:
integrating the N first classifications to characterize the assessment; and
formulating the assessment to have the first value based on a set of criteria.

16. The computing device of claim 11, wherein obtaining the response comprises:
enabling the first LLM based on the first value; and
presenting the communication to the first LLM to solicit the response.

17. The computing device of claim 11, wherein reviewing the response comprises:
parsing the response into response elements;
invoking the M second classifiers, each responsive to at least an aspect of one of the response elements, to operate on the response elements to produce M second classifications; and
integrating the M second classifications to generate the decision.

18. The computing device of claim 11, wherein at least one of the N first classifiers and the M second classifiers is a customized classifier.

19. The computerized method of claim 1, wherein at least one of the N first classifiers and the M second classifiers classifies at least one of a prompt injection, a jailbreak, a safety and security item, a malware detection, and a cyberattack.

20. A system comprising:
a large language model (LLM) configured to process a communication from a user; and
a computing device having an attack prevention system (APS) to protect the LLM, the APS comprising:
an evaluator configured to evaluate the communication using N first classifiers to provide N first classifications,
an analyzer configured to analyze the N first classifications to generate an assessment having a first value, the assessment characterizing an attack level in the communication,
wherein the analyzer obtains a response to the communication from the LLM based on the first value, and reviews the response using M second classifiers to generating a decision on the response,
wherein N is a positive integer and M is a positive integer equal to or different from N.
